(19) United States
(12) Patent Application Publication
(10) Pub. No.: US 2005/0102375 A1
(43) Pub. Date: May 12, 2005

(54) An Internet System for the Uploading, Viewing and Rating of Videos

(76) Inventor: Kivin Varghese, Danville, VA (US)

Correspondence Address: JEFFREY FURR, 253 N. MAIN STREET, JOHNSTOWN, OH, 43031, US

(21) Appl. No.: 10/605,758

(22) Filed: Oct. 23, 2003

(51) Int. Cl. G06F 15/16

(52) U.S. Cl. 709/219; 725/110; 725/112; 348/14.01; 709/203

(57) ABSTRACT

The present invention is a method to load visual video images or clips in at location, such as a website, that allows person a simplified method to access and view them. Having an uploader upload a video image or clip to a website, having viewers sign on to the website to view the video image or clip, giving the viewer access to view the video image or clip for a specific amount of time, and allowing said viewers to rate the video image or clip. An uploader provider can selects multiple levels of uploading of videos such as a premium feature like “bold” or “highlight” or “normal” for their listing. The uploader writes the title, a description, and sets the price for the clip.

### BACKGROUND OF INVENTION

1. Field of the Invention

This invention relates to the art of the viewing visual video images and more specifically, to the use of the Internet and a web site for this purpose.

2. Description of Prior Art

The current means of viewing and rating visual video images or clips are very simple. The video images are shown through a viewing device like a VCR or DVD players and rated manually by hand or they have to be shown through broadcast or cable television. There are a limited number of outlets for those who desire to have their video images or clips viewed. This is especially true for those videos the feature the new so called X (extreme) sports or stunts. Videos clips featuring these and other events such as funny videos, amateur videos or other types of videos need a proper location to market themselves.

The World Wide Web is currently a subject of intense and rapidly growing interest. The World Wide Web is composed of interconnected data sources that are accessible to computer users through data-communication networks such as the Internet. The data available on the World Wide Web have been assembled by private individuals, commercial companies, government agencies, and special interest organizations. Much of this assembled information is organized into Web pages. A Web site is a collection of Web pages (and possibly other data which, together with Web pages, are generically referred to as Web components) offered by a sponsoring entity, herein referred to as the site owner.

Large Web sites are typically organized hierarchically. For example, corporate Web sites often consist of smaller Web sites, each providing information about a business unit of the parent company.

The Web site itself resides on one or more server hosts. Web components stored on the server host are offered to users of the World Wide Web through a software program known as a Web server. A network user uploads or downloads data from a Web site through a browser, a software program running on the client host. The browser establishes contact with the Web server and issues a request for data stored on the server host. This results in data from the server host being downloaded into the browser. This data is typically a HyperText document specifying information required by the browser to display the Web page (i.e., formatting information specifying the structure of the page, or URLs of images that are to be placed on the page), embedded client software programs which run inside the browser (e.g., Java bytecode), and other content to be downloaded to the client computer or displayable through client software programs that add to the browser's functionality (sometimes referred to as “browser plug-ins”).

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

With the rapid growth of computer networking and requests for information from one computer to the next e.g. the Internet, it has become common practice for a provider of information (a “Server”) to provide each specific requester of information (a “Client”), with an electronic “token” (commonly referred to as a “Cookie”) for the purpose of “recognizing” the client and/or providing some pre-determined and pre-programmed level of customization at the discretion of the information provider.

The needs for a better method for the marketing of visual video images and clips, that is accurate, safe from fraud, inexpensive, and easy to use shows that there is still room for improvement within the art.

### SUMMARY OF INVENTION

The object of the present invention is to provide a method to load visual video images or clips in location that allows person a simplified method to access and view them.

Having an uploader upload a video image or clip to a website, having viewers sign on to a website to view the video image or clip, giving the viewer access to view the video image or clip for a specific amount of time, and allowing said viewers to rate the video image or clip.

An uploader can selects multiple levels of uploading of videos such as premium features like “bold” or “highlight” or “normal” for their listing. The uploader writes the title, a description, and sets the price for the clip.

Viewers, who are people who want to view the video images or clips, will have accounts which will be deducted when they want to view a video image or clip. After viewing the clip, the viewer has access to that clip for a set period of time such as 48 hours, after which they must have their account deducted to view the same clip again. Viewers can also rate the clip after viewing it and write a short note about the clip. There will be a size limit is set to per video image and/or clip.

The current invention utilizes the Internet. The Internet comprises a vast number of computers and computer networks that are interconnected through communication links. The interconnected computers exchange information various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

The process is more efficient, effective, accurate and functional than the current art.

Glossary of Terms

Browser: a software program that runs on a client host and is used to request Web pages and other data from server hosts. These data can be downloaded to the client's disk or displayed on the screen by the browser.

Client host: a computer that requests Web pages from server hosts, and generally communicates through a browser program.

Content provider: a person responsible for providing the information that makes up a collection of Web pages.

Embedded client software programs: software programs that comprise part of a Web site and that get downloaded into, and executed by, the browser.

Clip: a video stream that contains images and possible sound.

Cookies: data blocks that are transmitted to a client browser by a web site.

Hit: the event of a browser requesting a single Web component.

Host: a computer that is connected to a network such as the Internet. Every host has a hostname (e.g., mypc.mycompany.com) and a numeric IP address (e.g., 123.104.35.12).

HTML (HyperText Markup Language): the language used to author Web Pages. In its raw form, HTML looks like normal text, interspersed with formatting commands. A browser's primary function is to read and render HTML.

HTTP (HyperText Transfer Protocol): protocol used between a browser and a Web server to exchange Web pages and other data over the Internet.

HyperText: text annotated with links to other Web pages (e.g., HTML).

IP (Internet Protocol): the communication protocol governing the Internet.

Logfile: a file residing on the Web site in which the Web server logs information about browsers requesting Web components. The logfile typically contains one line per hit.

Pageview: the event of a browser downloading some or all of the Web components that make up a Web page and displaying the Web page. A pageview often consists of several hits.

Referral page: the URL of the Web page containing the HyperText link that led a visitor to the data currently being viewed. In most commercial browsers, the BACK button returns the visitor to this referral page.

Server host: a computer on the Internet that hands out Web pages through a Web server program.

Uploader: someone who wants to upload a video clip or image.

URL (Uniform Resource Locator): the address of a Web component or other data. The URL identifies the protocol used to communicate with the server host, the IP address of the server host, and the location of the requested data on the server host. For example, “http://www.lucent.com/work.html” specifies an HTTP connection with the server host www.lucent.com, from which is requested the Web page (HTML file) work.html.

UWU server: in connection with the present invention, a special Web server in charge of distributing statistics describing Web traffic.

Viewer: someone who wants to view the video image or clip.

Visit: a series of requests to a fixed Web server by a single person (through a browser), occurring contiguously in time.

Visitor: a person operating a browser and, through it, visiting a Web site.

Web component: a basic data building block that makes up a Web page. A Web component may contain text, HyperText, images, embedded client software programs, or other data displayable by a browser (such as, for example, QuickTime videos).

Web designer: a person, typically one skilled in graphical design, who has charge of designing Web pages.

Web master: the (typically, technically trained) person in charge of keeping a host server and Web server program running.

Web page: multimedia information on a Web site. A Web page is typically an HTML document comprising other Web components, such as images.

Web server: a software program running on a server host, for handing out Web pages.

Web site: a collection of Web pages residing on one or multiple server hosts and accessible through the same hostname (such as, for example, www.lucent.com).

### BRIEF DESCRIPTION OF DRAWINGS

Without restricting the full scope of this invention, the preferred form of this invention is illustrated in the following drawings:

FIG. 1 shows an overview of how a User accesses the system through the Internet;

FIG. 2 shows the standard logon web page;

FIG. 3 shows how a visual video image or clip file is uploaded to the system; and

FIG. 4 shows how a viewer views the video image or clip file.

### DETAILED DESCRIPTION

The current invention is a system and method for having someone upload a video image or clip to a website, having viewers sign on to the website to view the video image or clip, giving the viewer access to view the video image or clip for a specific amount of time, and allowing said viewers to rate the video image or clip.

Having an uploader 20 upload a video image or clip to a website, having viewers 10 sign on to the website 100 to view the video image or clip 40, giving the viewer access to view the video image or clip for a specific amount of time, and allowing said viewers to rate the video image or clip.

An uploader 20 provider can selects multiple levels of uploading of videos 40 such as a premium feature like “bold” or “highlight” or “normal” for their listing. The uploader writes the title, a description, and sets the price for the clip.

Viewers 10, who are people who want to view the video images or clips, will have accounts which will be deducted when they want to view a video image or clip. After viewing the clip, the viewer 10 has access to that clip for a set period of time such as 48 hours, and then must have their account deducted to view the same clip. Viewers 10 can also rate the clip after viewing it on a scale from 1 to 10, and write a short note about the clip.

There will be a size limit is set to per video image and/or clip.

The current invention utilizes the Internet. The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that affects the requesting of Web pages and the displaying of Web pages.

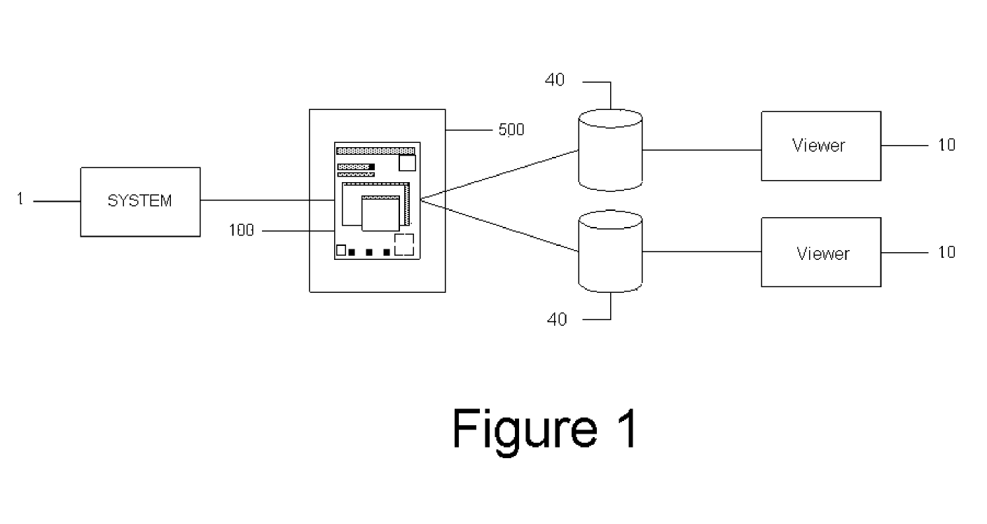

FIG. 1 illustrates a functional diagram of a computer network for World Wide Web access to the system 1 from a plurality of Viewers 10 to the Viewing web site 100. Accessing the Viewing web site 100 can be accomplished directly through a communication means such as a local Internet Service Provider, often referred to as ISPs, or through an on-line service provider like CompuServe, Prodigy, American Online, etc.

The Viewers 10 contact the Viewing web site 100 using an informational processing system capable of running an HTML compliant Web browser such as Microsoft's Internet Explorer, Netscape Navigator, Lynx and Mosaic. A typical system that is used is a personal computer with an operating system such as Windows 95, 98, 2000, XP or ME or Linus, running a Web browser. The exact hardware configuration of computer used by the Viewers 10, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

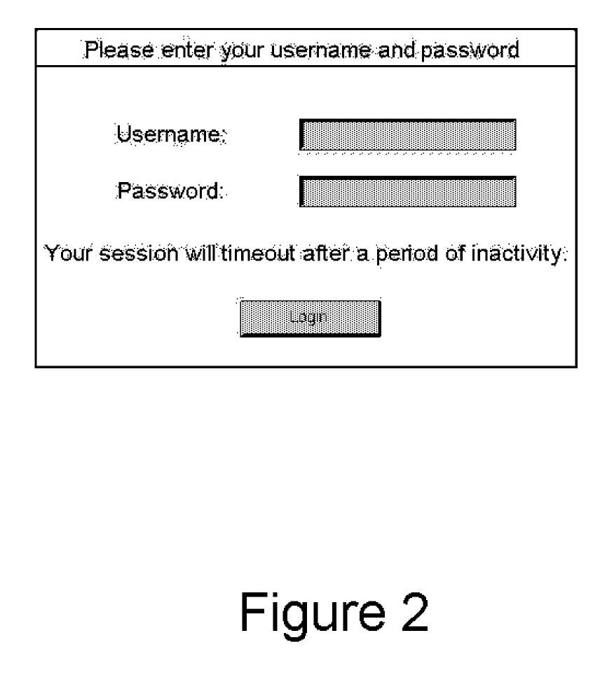

In one preferred embodiment of the invention, the Viewers 10 connect to the Viewing web site 100 through the Internet 500. The rating board is where the viewer 10 rates the visual video image or clip 40. In the preferred embodiment, the rating is a one to ten rating system with ten being the highest. The visual video image or clip 40 is a visual video image or clip 40 for the Viewer 10 to rate. In the preferred embodiment, the visual video image or clip 40 is randomly assigned when the Viewer 10 goes to the viewing web site 100. A comments input block allows the Viewer 10 to add word comments about the visual video image or clip 40 that he/she is rating The system 1 would have a standard logon web page as shown in FIG. 2. There would be a data entry field for Username and Password. The Username would have to be unique and the password would have to be at least eight characters. The web page will have a mechanism for Viewers 10 who forgets their password. This technology is well know in the art and therefore is not covered in great detail here. In the preferred embodiment, the visual video image or clips 40 will have specific information about the profile of the person or the image that is only available to those Viewer 10 who have signed on to the system. This insures the privacy of the system 1.

The viewing web site 100 would have an FAQ web page would be a standard FAQ web page. This technology is also well known in the art.

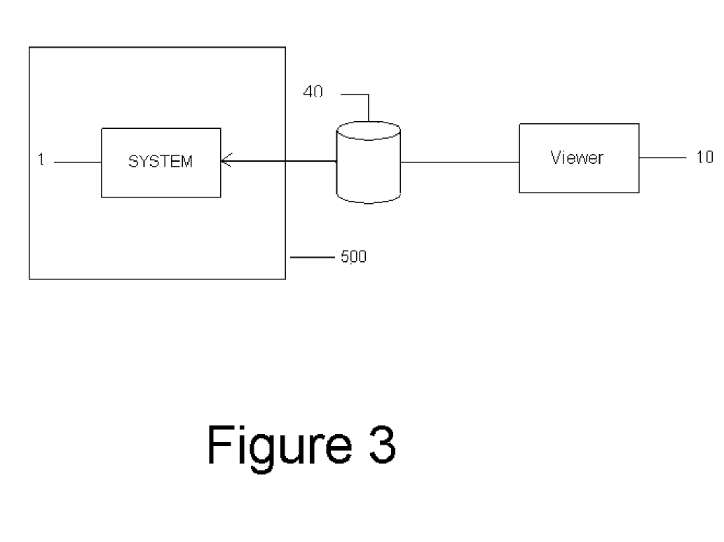

After signing on, as shown in FIG. 3, a Viewer 10 can upload a visual video image or clip 40 to the system 1. The visual video image or clip 40 will be in the form of a digital video image file. That file will be transmitted to the system 1 using a standard Internet browser and protocol.

Any standard video format can be used such as AVI, MPEG-1, MPEG-2, WMV, FLIC, Multi-page TIFF, GIF animation creation or any other video format.

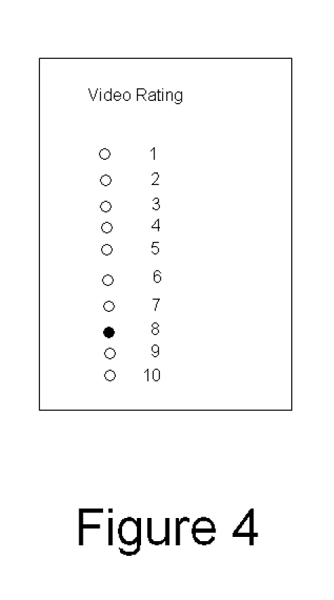

As shown in FIG. 4, in the preferred embodiment, the Viewers 10 can rate the visual video images 40 on a scale of one to ten with ten being the highest. There is a scale on the rating board which has numbers from one to ten and beside each number is data entry point. The viewer 10 clicks on that point with a mouse. The system 1 accepts that rating for the visual video image or clip 40. The system 1 combines this rating with all of the rating it received earlier from other users to produce an overall average The system 1 will then display the rating and number of raters.

The previously described version of the present invention has many advantages. The system 1 provides a method of marketing of visual video images and clips, which is inexpensive, and easy to use.

Although the present invention has been described in considerable detail with reference to certain preferred versions thereof, other versions are possible. For example, the viewing web site could use a different or new protocol to communicate or an Intranet could be used. Therefore, the point and scope of the appended claims should not be limited to the description of the preferred versions contained herein.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for viewing video images comprising:
an uploader loading a video image file to a website; and
a viewer viewing said video image file from said website.

2. The system according to claim 1 wherein said viewers rates the video images.

3. The system according to claim 1 wherein said uploader sets the quality of said video image file.

4. The system according to claim 1 wherein said uploader sets the fee to view said video image file.

5. The system according to claim 1 wherein said viewer has access to viewing said video file for a set period of time.

6. The system according to claim 1 wherein said system stores said video image file in a storage means.

7. The system according to claim 1 wherein said system has a size limit on the size of the video file.

8. The system according to claim 1 wherein said system can be used with a plurality of video formats.

9. The system according to claim 1 wherein said viewer having an account on said system.

10. The system according to claim 2 wherein said viewer rate a video file based on a scale of one to ten.

11. A method for viewing video images comprising the steps of:
having an uploader loading a video image file to a website; having a viewer viewing said video image file from said website.

12. The method according to claim 11 which includes the step of having said viewers rating the video images.

13. The method according to claim 11 which includes having said uploader setting the quality of said video image file.

14. The method according to claim 11 which includes having said uploader setting the fee to view said video image file.

15. The method according to claim 11 which includes having said viewer having access to viewing said video file for a set period of time.

16. The method according to claim 11 which includes storing said video image file in a storage means.

17. The method according to claim 11 which includes having a size limit on the size of the video file.

18. The method according to claim 11 which includes being used with a plurality of video formats.

19. The method according to claim 11 which includes having said viewer having an account.

20. The method according to claim 12 which includes having said viewer rating a video file based on a scale of one to ten.
